(19) United States
(12) Patent Application Publication
(10) Pub. No.: US 2008/0027646 A1
(43) Pub. Date: Jan. 31, 2008

(54) Navigation system

(75) Inventor: Yoshinori Kawabata, Kariya-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 11/790,113

(22) Filed: Apr. 24, 2007

(30) Foreign Application Priority Data
May 29, 2006 (JP) 2006-148533

(51) Int. Cl. G01C 21/00

(52) U.S. Cl. 701/224

(57) ABSTRACT

A navigation system calculates an original navigation route between a start point and an end point of a travel based on an input from a map data input unit or the like, and provides a navigation guidance based on the original navigation route. When another vehicle in a front intersection in front of a subject vehicle is found based on an image analysis of an image that is derived from a front camera of the subject vehicle, the navigation system determines whether making a left turn at the front intersection is difficult or not based on the result of the image analysis. When the left turn is determined to be difficult, the navigation system re-calculates the navigation route for avoiding the left turn at the front intersection and provides a voice message that notifies a driver of the subject vehicle that the original navigation route has been changed.

### CROSS REFERENCE TO RELATED APPLICATION

This application is based on and claims the benefit of priority of Japanese Patent Application No. 2006-148533 filed on May 29, 2006, the disclosure of which is incorporated herein by reference.

### FIELD OF THE INVENTION

The present invention generally relates to a navigation system and apparatus for use in a vehicle.

### BACKGROUND INFORMATION

A conventional navigation system for use in a vehicle basically provides a search function for searching an optimum route between a start point of a travel and a destination based on Dijkstra method or the like, and also provides an instruction function for instructing a driver of a vehicle to follow the optimum route by giving voice instructions, by showing a road map or the like. The conventional navigation system searches and calculates the optimum route toward the destination based on evaluation criteria such as the number of lanes in a road, the type of the road, the distance to the destination, traffic regulations, or the like. Then, the optimum route is determined to guide the driver along a route that has a highest evaluation value. However, the calculation of the optimum route does not takes into account the various conditions such as a size of the vehicle, a minimum turn radius, or the like from a point of view that the vehicle can make turns with ease at every intersection in the optimum route. That is, when the size of the vehicle and/or the minimum turn radius does not fit into the road width of the turning intersection of the optimum route, or when the turning angle at the turning intersection of the optimum route makes it difficult for the vehicle to follow the optimum route without 3-point turning, the optimum route to the destination provided by the navigation system causes a trouble especially for a larger size vehicle such as a truck or the like.

A technique disclosed in Japanese patent document JP-A-2002-148066 provides an optimum route toward the destination based on a consideration of turn conditions at the intersections of the optimum route. That is, for example, the search function in the above disclosure calculates the optimum route based on various information such as the road width, the intersecting angle, the vehicle size, the minimum turn radius and the like, and determines the ease of turning at the intersections of the optimum route. When some of the turns at the intersections of the optimum route are determined to be not easy, no-easy turn intersections are tried to be excluded from the optimum route in the above disclosure.

However, even when the driver of the vehicle uses the technique in the above disclosure, the optimum route guided by the conventional navigation system may force the driver to make turns at intersections without considering current traffic conditions. That is, for example, even when turning traffic at an approaching intersection in the optimum route looks like being obstructed by an obstacle such as a stopping vehicle, a construction fence or the like existing in a turning direction, the conventional navigation system instructs the driver to turn at the approaching intersection without considering the obstacle. As a result, the driver of the vehicle under a turn instruction may suffer from uncertainty if the approaching intersection allows a turn in the first place, and, when the driver has started turning, the uncertainty may turn out to be a difficulty that highly skillful maneuver is required for getting out of the situation, that is, either for completing the turn or for departing from the navigation route by giving up the turn (i.e., passing straight through the intersection).

### SUMMARY OF THE INVENTION

In view of the above and other problems, the present invention provides a navigation system that appropriately handles a difficult turn situation at an intersection in a navigation route when a driver of a vehicle is involved in the difficult turn situation in the navigation route that is calculated and provided by the navigation system.

The navigation apparatus equipped with a navigation route search function for searching a navigation route toward a destination from a start point and a route guidance function for providing a route guidance that guides the vehicle along the navigation route includes a front field detection unit that detects an obstacle stopping in an intersection in front of the vehicle and measures a size of the obstacle in the intersection, a turn condition determination unit that determines difficulty of making a turn at the intersection in front of the vehicle to a direction that accords with the navigation route, wherein the difficulty of making the turn is determined based on the size of the obstacle in the intersection detected by the front field detection unit, a size of the vehicle, and a width and an angle of a road to be traveled after making the turn at the intersection, and a control unit that provides at least one of a notification that notifies the difficulty of making the turn for a driver of the vehicle and a new navigation route that avoids the turn at the intersection in front of the vehicle based on a new route search. Then, at least one of the notification and the new navigation route is provided for the driver of the vehicle when the turn at the intersection in front of the vehicle is determined to be difficult by the turn condition determination unit.

Thus, the navigation system of the present disclosure provides at least one of a precautionary message for the driver that notifies that turning traffic at the front intersection is blocked by the obstacle and a new navigation route that avoids the turn at the front intersection in a timely manner, thereby removing from the driver of the vehicle a necessity of self-determination whether traffic at the front intersection is in a suitable condition for making a turn as well as decreasing a possibility of coming to a too-late conclusion that making the turn at the front intersection is too difficult. As a result, the driver of the vehicle is saved from being involved in making the difficult turn, that is, more practically, saved from exercising a difficult maneuver either to pass the obstacle for completing the turn at the front intersection or to return to straight traffic to go through the intersection without turning.

### BRIEF DESCRIPTION OF THE DRAWINGS

Other objects, features and advantages of the present invention will become more apparent from the following detailed description made with reference to the accompanying drawings, in which:

FIG. 1 shows a block diagram of a navigation system in an embodiment of the present disclosure;

FIG. 2 shows a flowchart of a control process in a control unit of the navigation system;

FIG. 3 shows an illustration of a plan view of vehicles at an intersection; and

FIG. 4 shows an illustrations of a plan view of vehicles at an intersection in another embodiment of the present disclosure.

### DETAILED DESCRIPTION

Embodiments of the present invention are described with reference to the accompanying the drawings. In the following description of the embodiments, the navigation system assumes the left side traffic and the vehicle is making a left turn. However, the present invention may be applicable to the right side traffic and the vehicle making a right turn when the left-right relationship is reversed.

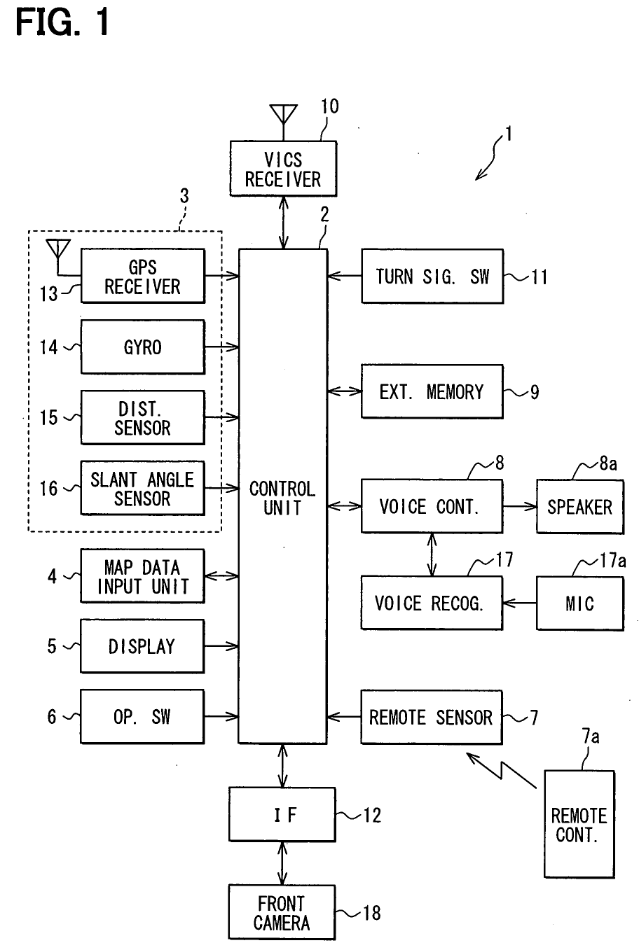

FIG. 1 shows a block diagram of a vehicular navigation system 1 for use in a vehicle in an embodiment of the present disclosure. FIG. 1 includes related components that is electrically coupled with the navigation system 1. In the navigation system 1, a position detector 3, a map data input unit 4, a display 5, operation switches 6, a remote controller sensor 7, a voice controller 8, an external memory 9, a VICS (a registered trademark in Japan) receiver 10 are connected to a control unit 2 that controls a navigation operation of the navigation system 1. Further, the navigation system includes a turn signal switch 11, and a camera interface 12 connected to the control unit 2.

The control unit 2 includes a microcomputer that has a CPU, a ROM, a RAM, an I/O interface, and the like with a bus line for connecting these components. The ROM in the microcomputer stores a program for vehicular navigation and the like, and the RAM temporarily stores processed data for executing the program as well as road map data derived from the map data input unit 4, traffic information received by the VICS receiver 10 (for use in Japan), image data acquired through the camera interface 12.

The position detector 3 includes, for example, a GPS receiver 13 for receiving a signal from a GPS satellites, a gyro sensor 14 for detecting a yaw rate, a distance sensor 15 for detecting a travel distance of the vehicle, a slant angle sensor 16 for detecting a slant angle of the vehicle, and the like. The position detector 3 is used to detect a current position of the vehicle as vehicle information.

The map data input unit 4 is a large volume information storage such as a CD-ROM, a DVD-ROM, and a HDD with a possible applicability of a non-volatile semiconductor memory. The information storage stores various information such as map data for drawing a map on a display apparatus, navigation route search and guidance data for searching and guiding the navigation route between the start point and the destination (i.e., traffic direction data for designating traffic directions such as a straight pass, a right/left turn and the like, a full road width, a one side road width of a center-lined road and the like), detailed intersection data such as a shape of the intersection, an intersecting angle of the roads and the like, background data for drawing a background of the map, location name data for displaying location names as well as a collection of databases such as facility name database, telephone number database and the like.

The display 5 is, for example, configured to display the map on a liquid crystal display unit, and is disposed at a proximity of a driver's seat in the vehicle. The display 5 displays a sizable road map that can be zoomed in and out to plural scales on a screen, and also displays in a superposing manner a pointer that indicates a current position and a traveling direction of the vehicle. When a route navigation function is activated, the navigation route toward the destination of the travel is displayed on the road map in the display 5. Further, various menus for user input and user search of the destination as well as an information screen and/or a help screen can also be displayed on the display 5.

The operation switches 6 take a form of mechanical switches and/or touch panel switches on and around the display 5, and provide various operation commands for the control unit 2 for executing functions of the navigation system 1 such as map scale change, menu screen selection, destination setting, route search, route guidance starting, current position correction, display screen change, volume control and the like.

The remote controller sensor 7 is disposed for receiving various operation command signals from a remote controller 7a. The remote controller sensor 7 provides those signals to the control unit 2.

The voice controller 8 includes a control circuit, a voice synthesizing circuit and an amplifier for controlling the voice recognizer 17 and for talking back through the speaker 8a to the driver who inputted his/her voice to the navigation system 1. The voice controller 8 outputs from the speaker 8a voice message such as navigation route guidance, help message for screen operations or the like. Further, the voice controller 8 provides a voice recognition result derived from the voice recognizer for the control unit 2.

The voice recognizer 17 includes a voice recognition unit for converting a voice from the microphone 17a to digital data, a voice recognition unit for voice recognition based on a comparison pattern dictionary. The voice recognizer 17 is configured to provide a recognition result of the user's voice for the control unit 2 through the voice controller 8. The voice recognizer 17 is capable of recognizing various voice commands that are defined respectively in a corresponding manner to the various operation commands from the operation switches 6. The voice commands recognized by the voice recognizer 17 are used to execute the various functions of the navigation system 1.

The external memory 9 is a non-volatile memory such as a flash memory or the like. The external memory 9 is writable and readable for storing data that may not be lost even when the power supply is turned off, and/or the data that is copied from the map data input unit 4 for frequent use for, for example, map drawing. In particular, the external memory 9 at least stores vehicle data of the subject vehicle such as vehicle width data that represents the vehicle width of the subject vehicle and minimum turn radius of the subject vehicle for use in a left turn verification function (described later).

The VICS receiver 10 includes a VICS sensor unit, a FM multi-broadcast receiver (not shown in the figure) for receiving traffic information from optical/radio beacon of the VICS station and for receiving traffic information through FM radio wave. The received information is provided from the receiver 10 for the control unit 2.

The turn signal switch 11 is a well-know type switch that controls blinking operation of a turn signal upon receiving a right turn preparation operation for turning right or a left turn preparation operation for turning left. The right turn preparation operation on the turn signal switch 11 provides a right turn signal for the control unit 2, and the left turn preparation operation on the turn signal switch 11 provides a left turn signal for the control unit 2.

The camera interface 12 is used to control signal exchange between the control unit 2 and a front camera 18 that is configured for imaging a front image of the vehicle. The control unit 2 provides an imaging operation start/stop signal for the camera 18, and the camera 18 in return provides front image data for the control unit 2. In the present embodiment, the front camera 18 is configured to image the front image of the vehicle while the navigation system 1 is being operated. In addition, the front camera 18 is capable of imaging a dark place with an assistance of an infrared camera, a high-speed camera or the like.

The control unit 2 is configured to execute, based on operation commands inputted from the operation switches 6 and/or the remote controller sensor 7 and voice commands inputted through the voice recognizer 17, various driving support functions such as a (well-known) map display function, a route search function for finding a navigation route between a start point and a destination point by utilizing the map data derived from the map data input unit 4, a route guidance function for providing route guidance for the driver of the vehicle based on the calculated navigation route, a telephone number search function, a zip code search function, a proprietary code search function, an alphabetical search function, a category search function, a nearest facility search function, a destination registration function, a place registration function, and the like. In terms of a relevance to the present disclosure, the control unit 2 controls the left turn verification function.

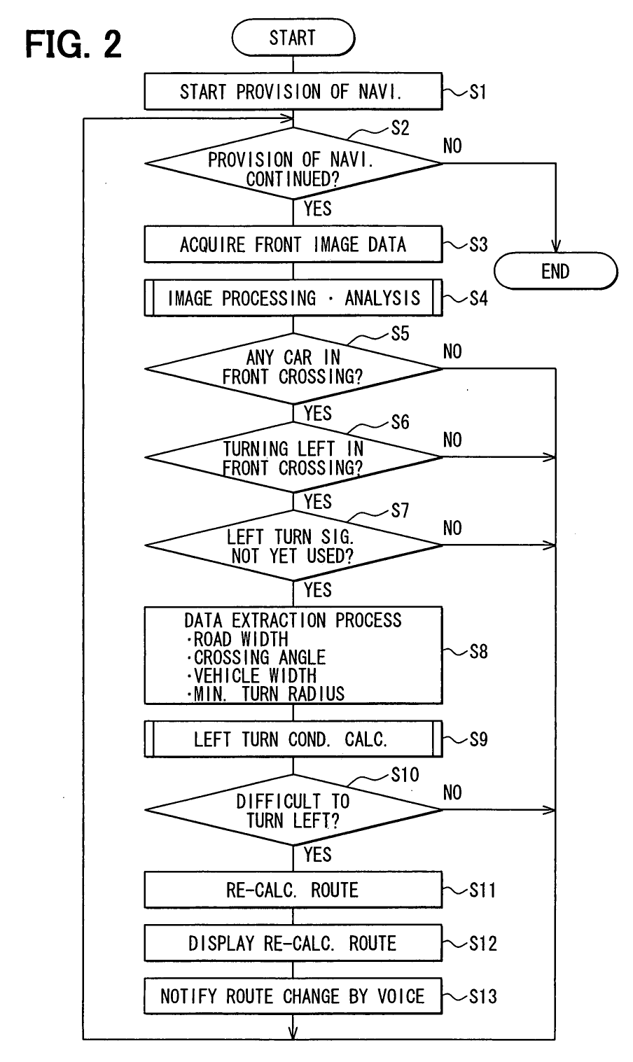

The left turn verification function is described with reference to a flowchart in FIG. 2. The flowchart describes an outline of a control process in the control unit 2 including the left turn verification function provided by an execution of a left turn verification routine (i.e., a program). The routine is executed when a route navigation to the destination specified by a user has been started (step S1). The routine determines, in the first place, whether or not provision of route navigation has been started in step S2.

The routine concludes itself when the route navigation has ended, that is, when the vehicle has arrived to the destination, or when the destination once specified is cleared (step S2: NO). When the route navigation is continued (step S2: YES), a front image of the vehicle is acquired by using the front camera 18 upon detecting that the vehicle is at a predetermined distance (e.g., 50 meters) from an approaching intersection of the navigation route in step S3. Then, an image processing and an image analysis are performed for processing the image from the front camera 18 (i.e., vehicle image extraction based on a binarizing processing and/or a characteristic point extraction processing) and analyzing the processed image in step S4. Further, when another vehicle is stopping at the approaching intersection, the amount of sticking out of the another vehicle into the approaching intersection is measured in the analysis of the processed image.

Then, based on a result of the analysis of the processed image, the routine determines whether the another vehicle is in the approaching intersection in a stopping condition in step S5. The routine returns to step S2 when the another vehicle is not in the approaching intersection (step S5: NO). The routine proceeds to step S6 when the another vehicle is determined to be in the approaching intersection (step S5: YES).

Then, the routine determines whether the vehicle is going to turn left at the approaching intersection based on the navigation route in step S6. The routine returns to step S2 when the vehicle is not going to turn left at the approaching intersection (step S6: NO). The routine proceeds to step S7 when the vehicle is determined to be turning left at the approaching intersection (step S6: YES).

Then, the routine determines whether the turn signal switch has not yet been used for a left turn notification based on an input of a left turn signal from the turn signal switch 11 in step S7. When the turn signal switch has been used (step S7: NO), the routine returns to step S2. When the turn signal switch has not been used (step S7: YES), the routine collects data required for determining whether the left turn at the approaching intersection is difficult from the map data input unit 4 and the external memory 9 in step S8.

More practically, the routine at least extracts in step S8 the road width data of a currently traveled road, road width data of the road to be traveled after turning at the approaching intersection (in particular, the road width of the leftward portion), intersecting angle data of the approaching intersection (in particular, the angle between the currently traveled road and the leftward portion of the intersecting road), vehicle width data, and minimum turn radius data. In this case, the road width data represents the half width of the road when the road has a center line, or represents the full width of the road when the road has no center line.

Then, the routine executes a left turn condition calculation in step S9. The routine determines whether the left turn of the vehicle at the approaching intersection is difficult based on the condition calculation that utilizes the result of the image processing in step S4 (in particular, the amount of sticking out of the stopping another vehicle into the approaching intersection) and the data extracted in step S8.

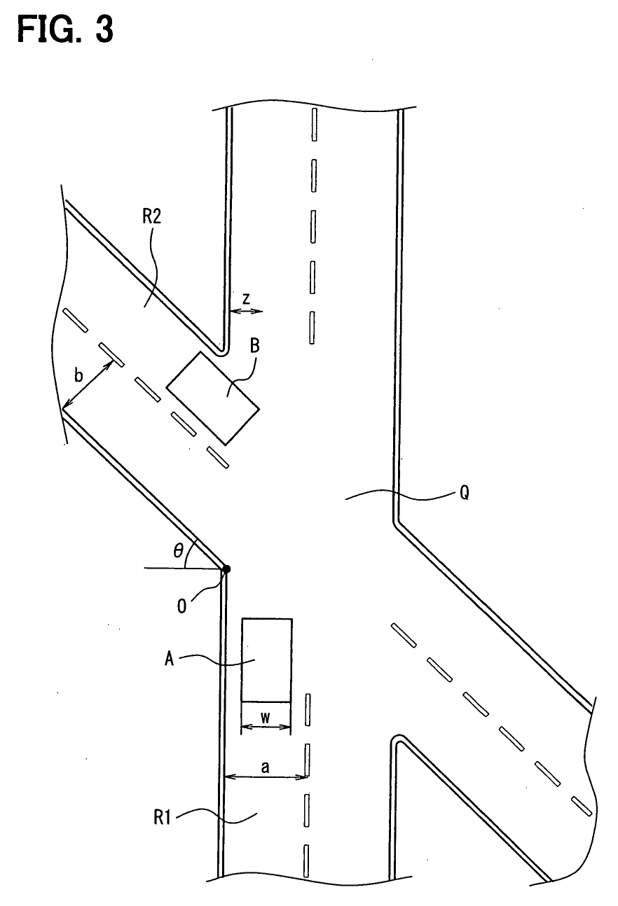

More practically, the left turn condition operation is performed in the following manner. That is, the situation is shown as an illustration of vehicles and the road in FIG. 3 for representing a positional relationship of the vehicles and the road in a plan view. In the illustration, the vehicle A traveling on a road R1 that leads to an intersection Q, and another vehicle B that is stopping at the intersection in a sticking out manner from a left side on an opposite lane of an intersecting road R2 are shown in the figure, with a road with ‘a’ of the road R1 (in this case, a half width of the center-lined road), a road width ‘b’ of the road R2 (in this case, a half width of the center-lined road), an intersecting angle θ of the intersection Q, a vehicle width ‘w’ of the vehicle A, and the amount ‘z’ of sticking out of the another vehicle B into the intersection Q.

The vehicle A can make a left turn at the intersection Q without being obstructed by the vehicle B when the following conditions are met. That is, a first condition that an expected turn radius Rz is smaller than a minimum turn radius R of the vehicle A is denoted as an Equation 1.

Rz=\sqrt{(a−z²)−(b cos θ)²}>R [Equation 1]

A second condition for the left turn is that the vehicle A does not interfere with a corner portion O of the intersection Q, and the second condition is denoted as an Equation 2.

$$b sin ( {tan}^{- 1} \frac{cos θ}{b} ) > w \qquad [ Equation 2 ]$$

Then, in step S10, the routine determines whether the left turn at the intersection Q is difficult. In this case, the routine determines the left turn is not difficult when both conditions 1 and 2 are fulfilled (step S10: NO), and returns to step S2. Otherwise, the routine determines that the left turn is difficult (step S10: YES), and proceeds to step S11.

Then, in step S12, the routine reroutes the navigation route toward the destination, that is, re-searches the navigation route that avoids the left turn at the approaching intersection.

In this case, the control unit 2 may provide a voice message for the driver from the speaker 8a, so as to notify that the left turn at the approaching intersection is difficult when the difficulty of the left turn is detected. Further, when avoiding the left turn at the approaching intersection leads to a long detour based on the re-search of the navigation route, the re-search of the navigation route may be cancelled, and a voice message that warns the driver to proceed with caution for making the left turn at the approaching intersection may be provided from the speaker 8a.

After re-searching the navigation route, the routine displays the re-searched navigation route on the road map that is being displayed on the display 5 in step S12, and the routine provides from the speaker 8a the voice message that the navigation route to the destination has been changed in step S13. Then, the routine returns to step S2.

In this manner, the navigation system 1 of the present disclosure assists the driver of the vehicle in finding a new navigation route toward the destination in case that an obstacle in the approaching intersection is making it difficult for the vehicle to turn left during the provision of the route navigation, and in providing a voice message that the navigation route has been changed for avoiding the left turn. In other words, the advantage of the navigation system 1 is characterized in that the driver of the vehicle is freed from making by him/herself a decision whether the left turn at the approaching intersection for following an original navigation route is difficult or not, as well as less likely to suffer from making in vain a decision that he/she should proceed with the left turn at the approaching intersection. That is, the driver of the vehicle is saved from being involved in a complicated driving operation for making the left turn with a sway from the obstacle in the intersection, or a complicated driving operation for quitting a once-determined left turn to return to going straight through the approaching intersection. As a result, the driver of the vehicle can easily cope with an ambiguous situation that the left turn at the approaching intersection may lead to a difficult maneuver regardless of the decision to proceed with the left turn or the decision to proceed without the left turn.

Further, the re-search of the navigation route and/or the notification of the route change is provided at the predetermined distance prior to approaching the intersection, thereby providing enough time for the driver to respond.

In the present embodiment, the re-search of the navigation route and/or the notification of the route change is not performed after the turn switch operation for indicating the left turn (step S7 in the flowchart in FIG. 2). This configuration is intended to prevent the driver to be put in confusion by providing the re-search and/or the notification immediately before the intersection where the left turn seem to be difficult. The step S7 may be omitted from the process when the consideration for the confusion is not required.

Although the present invention has been fully described in connection with the preferred embodiment thereof with reference to the accompanying drawings, it is to be noted that various changes and modifications will become apparent to those skilled in the art.

For example, the control unit 2 may be configured to determine the difficulty of the left turn when the vehicle is approaching an intersection where the vehicle is not scheduled to turn left according to the navigation route with an operation that indicates the left turn (e.g., an input of a left turn signal from the turn signal switch 11), and may provide for the driver of the vehicle a warning that the left turn is difficult when the left turn at the approaching intersection is determined to be difficult.

In this manner, the driver who is departing from the navigation route at will may also be effectively assisted by the navigation system 1 when the left turn at the approaching intersection is determined to be difficult, because the difficulty is notified to the driver in advance.

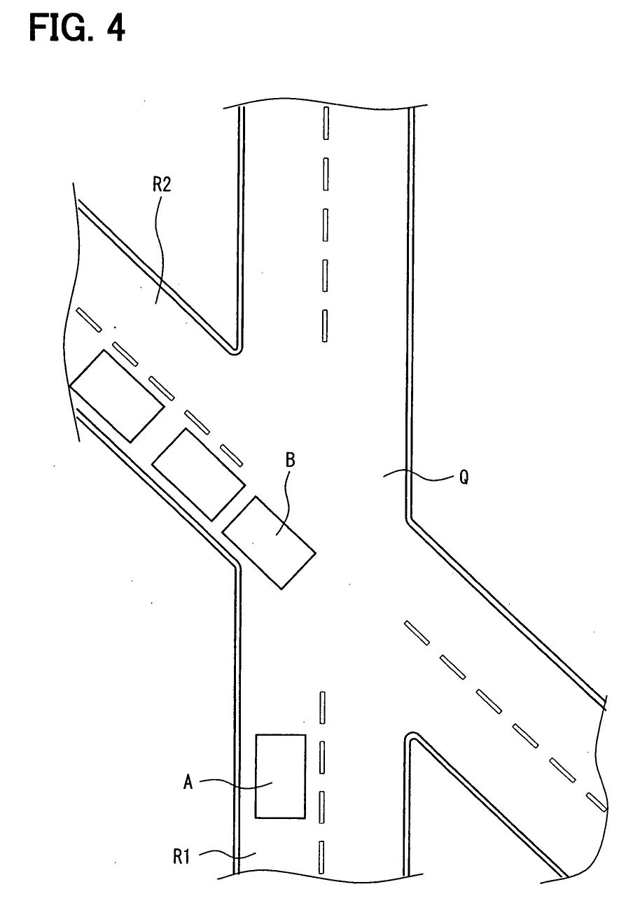

Further, the navigation system 1 may be configured to provide the re-search of the navigation route and/or the notification of the route change for the situation that the road R2 is congested and the vehicle B is sticking out into the intersection Q in a stopping condition as shown in FIG. 4 when the vehicle A is making the left turn at the intersection Q.

Furthermore, the front camera 18 for recognizing the situation in front of the vehicle including the approaching intersection may be replaced with other measures such as a use of a radar device for scanning a front field, an acquisition of required data (e.g., the sticking-out amount into the intersection and the like) from an inter-vehicle communication with other vehicles or the like.

Furthermore, the obstacle on the road at the intersection may include the vehicle as well as a fence or the like for the road construction work.

Such changes and modifications are to be understood as being within the scope of the present invention as defined by the appended claims.

What is claimed is:

1. A navigation apparatus for use in a vehicle, the navigation apparatus having a navigation route search function for searching a navigation route toward a destination from a start point and a route guidance function for providing a route guidance that guides the vehicle along the navigation route, the navigation apparatus comprising:
a front field detection unit that detects an obstacle stopping in an intersection in front of the vehicle and measures a size of the obstacle in the intersection;
a turn condition determination unit that determines difficulty of making a turn at the intersection in front of the vehicle to a direction that accords with the navigation route, wherein the difficulty of making the turn at the intersection is determined by following attributes detected by the front field detection unit such as the size of the obstacle in the intersection, a size of the vehicle, and a width and an angle of a road to be traveled after making the turn at the intersection; and
a control unit that provides at least one of a notification that notifies the difficulty of making the turn for a driver of the vehicle and a new navigation route that avoids making the turn at the intersection in front of the vehicle based on a new route search, wherein at least one of the notification and the new navigation route is provided when the difficulty of making the turn at the intersection is determined to meet a predetermined criterion by the turn condition determination unit.

2. The navigation apparatus as in claim 1,
wherein the turn condition determination unit determines the difficulty of making the turn at the intersection in front of the vehicle when the vehicle is traveling at a predetermined distance before the intersection at which the route guidance function is expected to provide the route guidance for making the turn.

3. The navigation apparatus as in claim 1,
wherein the turn condition detection unit determines the difficulty of making the turn that is indicated by an operation of a turn signal of the vehicle when the operation of the turn signal of the vehicle is started in an approach of the vehicle to an intersection at which the route guidance function is not expected to provide the route guidance for making the turn, and
the control unit provides a notification that notifies the driver of the vehicle of the difficulty of making the turn at the intersection when the difficulty of making the turn at the intersection is determined to meet the predetermined criterion by the turn condition determination unit.

4. A method for navigating a vehicle, the method including a navigation route search function for searching a navigation route toward a destination from a start point and a route guidance function for providing a route guidance that guides the vehicle along the navigation route, the method comprising:
detecting an obstacle stopping in an intersection in front of the vehicle and measuring a size of the obstacle in the intersection;
determining difficulty of making a turn at the intersection in front of the vehicle to a direction that accords with the navigation route, wherein the difficulty of making the turn at the intersection is determined by examining following attributes derived from an obstacle detection procedure such as the size of the obstacle in the intersection, a size of the vehicle, and a width and an angle of a road to be traveled after making the turn at the intersection; and
providing at least one of a notification that notifies the difficulty of making the turn for a driver of the vehicle and a new navigation route that avoids making the turn at the intersection in front of the vehicle based on a new route search, wherein at least one of the notification and the new navigation route is provided when the difficulty of making the turn at the intersection is determined to meet a predetermined criterion.
